(19) United States
(12) Patent Application Publication
(10) Pub. No.: US 2025/0301949 A1
(43) Pub. Date: Oct. 2, 2025

(54) ROBOT LAWN MOWER AND OPERATION METHOD THEREOF

(71) Applicant: URSrobot AI Inc., Taipei City (TW)

(72) Inventors: Chien-Tung CHEN, Taipei City (TW); Chung-Hou WU, Taipei City (TW); Chao-Cheng CHEN, Taipei City (TW); Wen-Wei CHIANG, Taipei City (TW); Yi-Jin LIN, Taipei City (TW)

(21) Appl. No.: 19/088,692

(22) Filed: Mar. 24, 2025

(30) Foreign Application Priority Data
Mar. 26, 2024 (TW) 113111287

(51) Int. Cl. A01D 34/00; A01D 34/74

(52) U.S. Cl. CPC A01D 34/008; A01D 34/74

(57) ABSTRACT

An operation method of a robot lawn mower includes steps of: selecting a working height from among reference heights recorded in a lookup table that is stored in the robot lawn mower; determining whether the working height is greater than a desired height; adjusting a height of a cutting module of the robot lawn mower by one of controlling the cutting module to move to the desired height in response to determining that the working height is not greater than the desired height, and controlling the cutting module to move to the working height in response to determining that the working height is greater than the desired height; and after adjusting the height of the cutting module, controlling the cutting module to operate for mowing and controlling the robot lawn mower to move along a planned path.

### CROSS-REFERENCE TO RELATED APPLICATION

This application claims priority to Taiwanese Invention patent application No. 113111287, filed on Mar. 26, 2024, and incorporated by reference herein in its entirety.

### FIELD

The disclosure relates to a robot lawn mower and an operation method thereof.

### BACKGROUND

In order to efficiently maintain the lawn, a conventional robot lawn mower is used to automatically cut lawn grass. However, the conventional robot lawn mower cuts lawn grass in a single manner and cannot be adapted to uneven conditions (e.g., varieties of plants, different growth conditions of plants, density variations of plants, and so on), which cause different resistance exerted on the conventional robot lawn mower, of lawn grass in the lawn. Accordingly, the uneven conditions of lawn grass may adversely impact uniformity of lawn grass mowed by the conventional robot lawn, reducing quality of mowing. Even more, a motor of the conventional robot lawn mower that drives operations of a cutting module (e.g., a blade disc, a cutting disc, a knife plate, a blade plate, etc.) of the conventional robot lawn mower may be prone to damage.

### SUMMARY

Therefore, an object of the disclosure is to provide a robot lawn mower and an operation method of the robot lawn mower that can alleviate at least one of the drawbacks of the prior art.

According to one aspect of the disclosure, the robot lawn mower includes a device body, a moving module, a cutting module, a storage module, and a control module that is electrically connected to the storage module, the cutting module and the moving module.

The moving module is configured to drive the robot lawn mower to move.

The cutting module is disposed at a lower portion of the device body, and is configured to be movable in a vertical direction relative to the device body between a maximum height where the cutting module is closest to the device body and a minimum height where the cutting module is most away from the device body.

The storage module is configured to store a current threshold, data that is related to a planned path along which the robot lawn mower is to move for mowing, and a lookup table that records a plurality of reference heights of the cutting module and a plurality of reference current values corresponding respectively to the reference heights.

The control module is configured to implement an operation method that includes
according to the current threshold and the reference current values in the lookup table, selecting a working height from among the reference heights in the lookup table,
determining whether the working height is greater than a desired height,
adjusting a height of the cutting module by one of controlling the cutting module to move to the desired height in response to determining that the working height is not greater than the desired height, and controlling the cutting module to move to the working height in response to determining that the working height is greater than the desired height, and
after adjusting the height of the cutting module, controlling the cutting module to operate for mowing and controlling the moving module to drive the robot lawn mower to move along the planned path.

According to another aspect of the disclosure, the operation method to be implemented by the control module that is previously described, and includes steps of:
according to the current threshold and the reference current values in the lookup table, selecting a working height from among the reference heights in the lookup table;
determining whether the working height is greater than a desired height;
adjusting a height of the cutting module by one of controlling the cutting module to move to the desired height in response to determining that the working height is not greater than the desired height, and controlling the cutting module to move to the working height in response to determining that the working height is greater than the desired height; and
after adjusting the height of the cutting module, controlling the cutting module to operate for mowing and controlling the moving module to drive the robot lawn mower to move along the planned path.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a robot lawn mower according to an embodiment of the disclosure.

FIG. 2 is a side view illustrating a cutting module of the robot lawn mower at a maximum height according to an embodiment of the disclosure.

FIG. 3 is a side view illustrating the cutting module of the robot lawn mower at a minimum height according to an embodiment of the disclosure.

FIGS. 4 to 6 are flow charts illustrating an operation method of the robot lawn mower according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

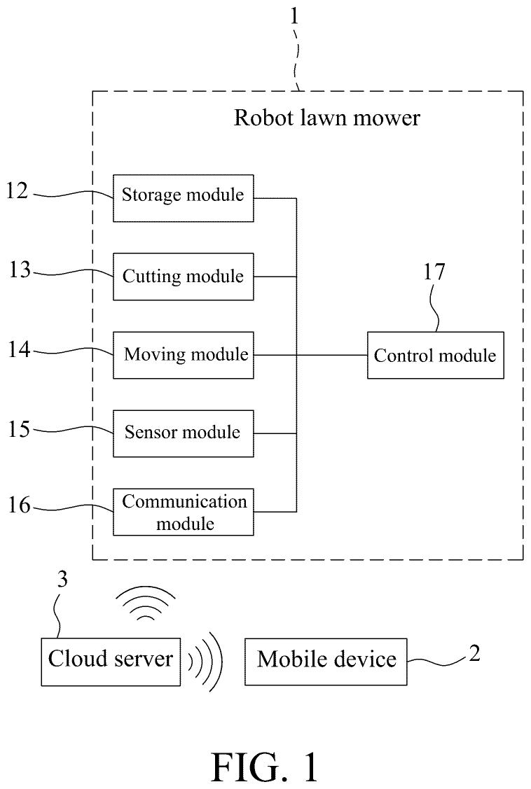

Referring to FIGS. 1 to 3, a robot lawn mower 1 according to an embodiment of the disclosure is illustrated. The robot lawn mower 1 includes a device body 11, a storage module 12, a cutting module 13, a moving module 14, a sensor module 15, a communication module 16, and a control module 17 that is electrically connected to the storage module 12, the cutting module 13, the moving module 14, the sensor module 15 and the communication module 16.

The control module 17 may be implemented by a processor, a central processing unit (CPU), a microprocessor, a micro control unit (MCU), a system on a chip (SoC), or any circuits configurable/programmable in a software manner and/or hardware manner to implement functionalities discussed in this disclosure.

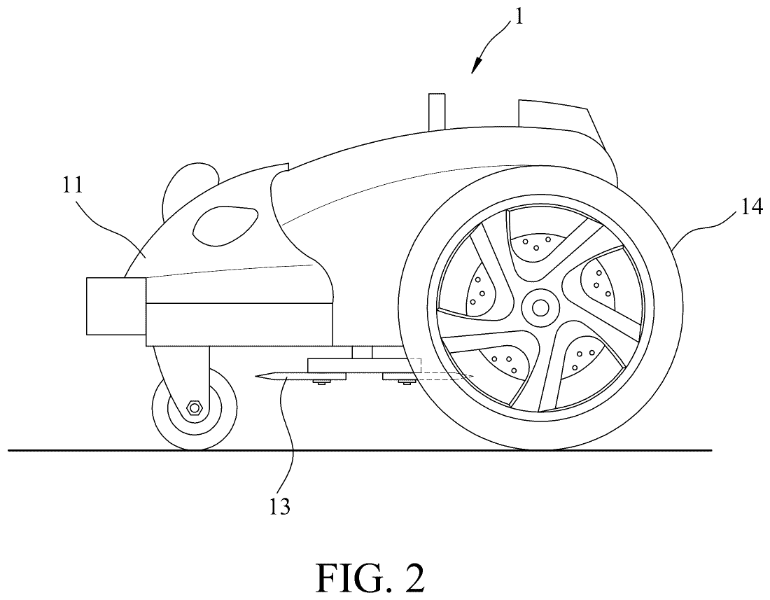

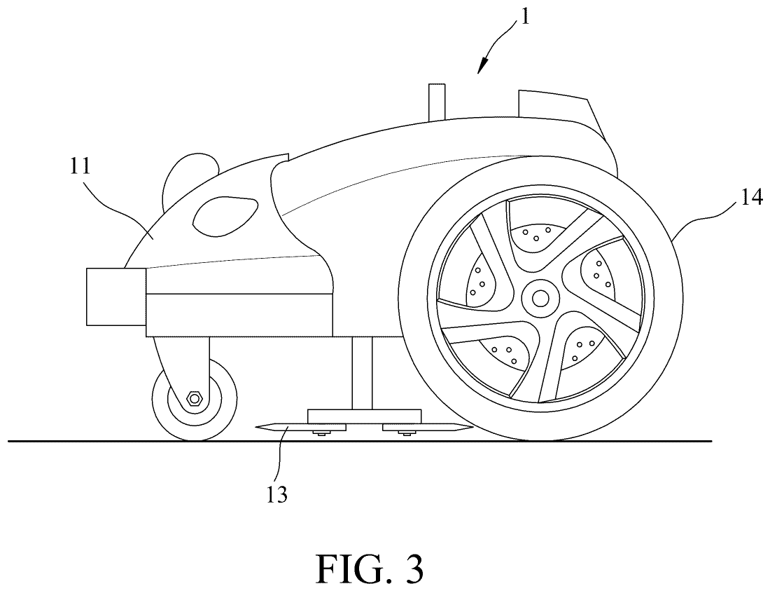

As shown in FIGS. 2 and 3, the cutting module 13 is disposed at a lower portion of the device body 11. The cutting module 13 is configured to be movable in a vertical direction relative to the device body 11 between a maximum height (see FIG. 2) where the cutting module 13 is closest to the device body 11 and a minimum height (see FIG. 3) where the cutting module 13 is most away from the device body 11. In this embodiment, the cutting module 13 includes a motor and a blade disc (also known as a cutting disc, a knife plate or a blade plate). The control module 17 is configured to obtain a mowing command that indicates a desired height for the cutting module 13.

The moving module 14 at least includes a set of wheels (see FIG. 2) and a motor (not shown). In this embodiment, the set of wheels of the moving module 14 includes four wheels, two of which are differential wheels (driven wheels) driven respectively by two motors, and the other two of which are auxiliary wheels. The moving module 14 is configured to drive the robot lawn mower 1 to move.

The sensor module 15 is configured to obtain a moving distance of the robot lawn mower 1. The sensor module 15 may be implemented to include a inertial measurement unit (IMU) that outputs data related to angular velocity and accelerations of the robot lawn mower 1 to the control module 17, a wheel encoder that outputs data related to an angular position of the wheel of the robot lawn mower 1 to the control module 17, and a global positioning system (GPS) device that supports techniques of real time kinematic (RTK) and that outputs data related to GPS positioning information of the robot lawn mower 1 to the control module 17. Then, the control module 17 computes the moving distance based on the data received from the sensor module 15. For example, the moving distance may be calculated by a product of a perimeter of the wheel and a number of revolutions of the wheel obtained by the wheel encoder, or may be calculated based on the GPS positioning information obtained by the GPS device. In some embodiments, the sensor module 15 further includes an independent processor for computing the moving distance, and the sensor module 15 sends information about the moving distance to the control module 17. Since implementation of obtaining the moving distance has been well known to one skilled in the relevant art, detailed explanation of the same is omitted herein for the sake of brevity.

The communication module 16 is configured to communicate with a cloud server 3 (see FIG. 1). The cloud server 3 communicates with a mobile device 2 (see FIG. 1) (e.g., a smartphone, but not limited thereto), which is usually own by a user of the robot lawn mower 1. The communication module 16 may be implemented to be a network interface controller or a wireless transceiver that supports wireless communication standards, such as Bluetooth® technology standards, Wi-Fi technology standards and/or cellular network technology standards (e.g., Long-Term Evolution, the third generation, the fourth generation, and/or the fifth generation, of wireless mobile telecommunications technology, and/or the like, but not limited thereto). Communications among the communication module 16, the cloud server 3 and the mobile device 2 may involve the Internet, but is not limited thereto. It is worth to note that in one embodiment, the mobile device 2 generates the mowing command, and sends the mowing command via the cloud server 3 to the robot lawn mower 1, but the disclosure is not limited thereto. Since implementation of techniques of wired and wireless communication has been well known to one skilled in the relevant art, detailed explanation of the same is omitted herein for the sake of brevity.

The storage module 12 may be implemented by random access memory (RAM), double data rate synchronous dynamic random access memory (DDR SDRAM), read only memory (ROM), programmable ROM (PROM), flash memory, a hard disk drive (HDD), a solid state disk (SSD), electrically-erasable programmable read-only memory (EEPROM) or any other volatile/non-volatile memory devices, but is not limited thereto. The storage module 12 is configured to store a current threshold, data that is related to a planned path along which the robot lawn mower 1 is to move for mowing, and a lookup table that records a plurality of reference heights of the cutting module 13 and a plurality of reference current values corresponding respectively to the reference heights. Every consecutive two of the reference heights recorded in the lookup table have a unit-height interval (e.g., 1 cm). In addition, the maximum height is over a first one (i.e., a top one) of the reference heights, and the maximum height and the first one of the reference heights have the unit-height interval. Moreover, the minimum height corresponds to a last one (i.e., a bottom one) of the reference heights. The current threshold is a maximum current value of electric current used by the cutting module 13 that is capable of normally and stably operating. It is worth to note that the planned path is created by using simultaneous localization and mapping (SLAM) algorithms.

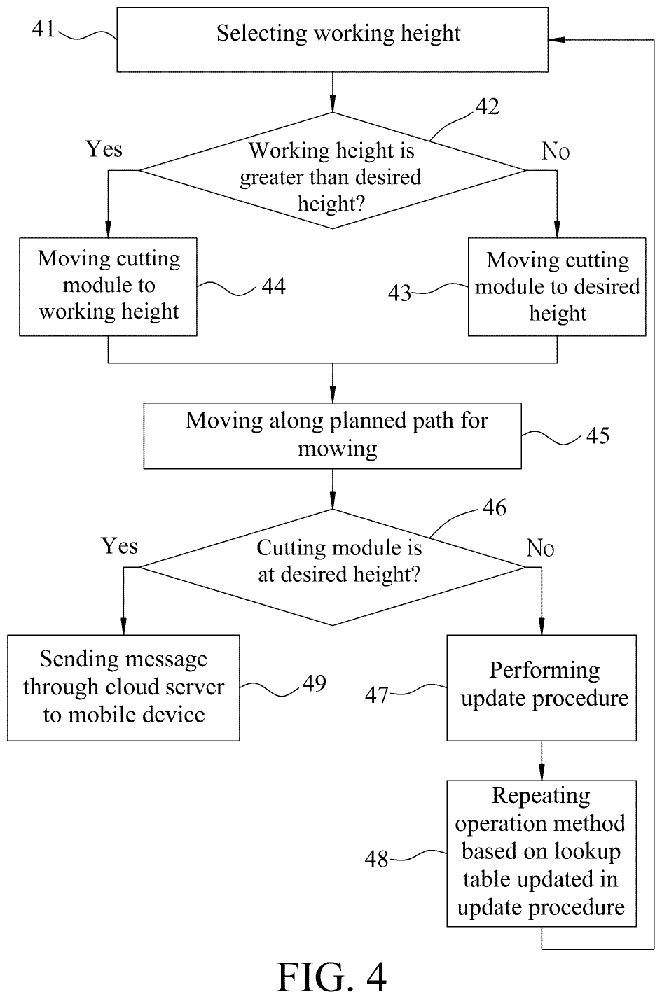

Referring to FIG. 4, an operation method of the robot lawn mower 1 according an embodiment of the disclosure is illustrated. The operation method is to be implemented by the control module 17 of the robot lawn mower 1 that is previously described. The operation method includes steps 41 to 49 delineated below.

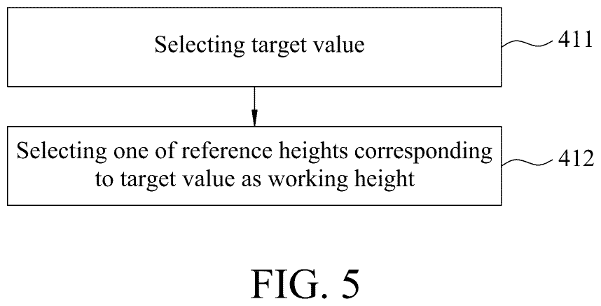

In step 41, according to the current threshold and the reference current values in the lookup table, the control module 17 selects a working height from among the reference heights in the lookup table. Specifically, step 41 includes sub-steps 411 and 412 shown in FIG. 5 and delineated below.

In sub-step 411, the control module 17 selects one of the reference current values that is less than the current threshold as a target value. In particular, the target value is a greatest one among the reference current values less than the current threshold, but is not limited thereto. In other embodiments, the target value is a second greatest one among the reference current values less than the current threshold.

In sub-step 412, the control module 17 selects one of the reference heights that corresponds to the target value as the working height. In particular, the working height is a least one among the reference heights corresponding to the target value.

It should be noted that the less a height of the cutting module 13, the more lawn grass to be cut by the cutting module 13, and hence the greater resistance encountered by the cutting module 13, the heavier a load on the cutting module 13 and the higher operating current used by the cutting module 13. The motor of the cutting module 13 is prone to damage when having prolonged exposure to a high electric current. In order to prevent the cutting module 13 from being damaged, the control module 17 will stop operation of the cutting module 13 when it is determined that the operating current used by the cutting module 13 exceeds the current threshold stored in the storage module 12. That is to say, the current threshold corresponds to an extreme of a workload affordable by the cutting module 13 without having to sacrifice quality of mowing.

In step 42, the control module 17 determines whether the working height is greater than a desired height. Thereafter, the control module 17 adjusts the height of the cutting module 13 based on a result of the aforesaid determination. Specifically, in response to determining that the working height is not greater than the desired height, a procedure flow of the operation method proceeds to step 43. On the other hand, in response to determining that the working height is greater than the desired height, the procedure flow proceeds to step 44.

In step 43, the control module 17 controls the cutting module 13 to move to the desired height.

In step 44, the control module 17 controls the cutting module 13 to move to the working height. It is worth to note that as what have been explained previously, the less the height of the cutting module 13, the greater the resistance encountered by the cutting module 13 and the higher the operating current used by the cutting module 13. A condition that the working height is greater than the desired height is equivalent to a condition that the desired height is less than the working height. The operating current is expected to exceed the current threshold when the cutting module 13 operates at the desired height, and thereby the cutting module 13 would operate unstably and abnormally. Thus, to prevent unstable and abnormal operation of the cutting module 13, the control module 17 controls the cutting module 13 to move to the working height at first when it is determined that the working height is greater than the desired height.

After adjusting the height of the cutting module 13, in step 45, the control module 17 controls the cutting module 13 to operate for mowing and controls the moving module 14 to drive the robot lawn mower 1 to move along the planned path.

In response to determining that the robot lawn mower 1 has completed the planned path, in step 46, the control module 17 determines whether the cutting module 13 is at the desired height. In response to determining that the cutting module 13 is not at the desired height, the procedure flow proceeds to step 47. Otherwise, in response to determining that the cutting module 13 is at the desired height, the procedure flow proceeds to step 49.

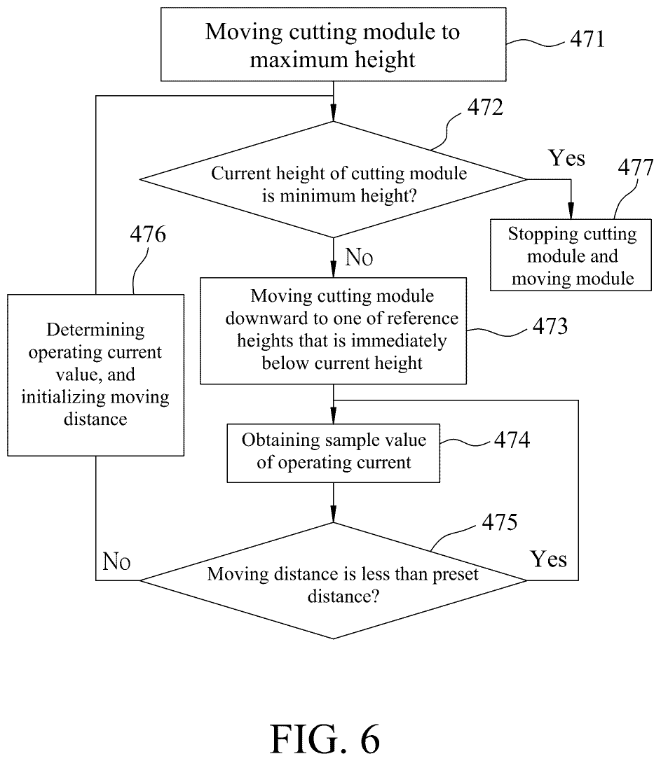

In step 47, the control module 17 performs an update procedure as shown in FIG. 6. In the update procedure, for each of the reference heights recorded in the lookup table, the control module 17 controls the cutting module 13 to move to and operate at the reference height, obtains an operating current value of operating current that is used by the cutting module 13 operating at the reference height. It is worth to note that the control module 17 obtains the operating current value from a current detector (not shown) of the robot lawn mower 1, and the current detector may be implemented to be independent from the control module 17 or be integrated into the control module 17. Thereafter, the control module 17 updates the lookup table based on the operating current values that are obtained respectively for the reference heights. In particular, the control module 17 updates the lookup table by replacing the reference current values that correspond respectively to the reference heights respectively with the operating current values that are obtained respectively for the reference heights. Specifically, the update procedure includes steps 471 to 477 delineated below.

In step 471, the control module 17 controls the cutting module 13 to move to the maximum height. After controlling the cutting module 13 to move to the maximum height, the control module 17 performs a sub-procedure that includes steps 472 to 477.

In step 472, the control module 17 determines whether a current height of the cutting module 13 is the minimum height. In response to determining that the current height of the cutting module 13 is not the minimum height, a flow of the update procedure proceeds to step 473. Oppositely, in response to determining that the current height of the cutting module 13 is the minimum height, the flow of the update procedure proceeds to step 477.

In step 473, the control module 17 controls the cutting module 13 to move downward in the vertical direction by the unit-height interval to one of the reference heights that is immediately below the current height, and then controls the moving module 14 to drive the robot lawn mower 1 to move forward.

In step 474, the control module 17 obtains a sample value of the operating current used by the cutting module 13 that is operating at said one of the reference heights.

During controlling the moving module 14 to drive the robot lawn mower 1 to move forward, in step 475, the control module 17 determines whether the moving distance obtained by the sensor module 15 is not less than a preset distance (e.g., 1 m, but not limited thereto). In response to determining that the moving distance is less than the preset distance, the flow of the update procedure goes back to step 474, and steps 474 and 475 are repeated until the moving distance is not less than the preset distance. Contrarily, in response to determining that the moving distance is not less than the preset distance, the flow of the update procedure proceeds to step 476.

In step 476, the control module 17 determines the operating current value for said one of the reference heights based on the sample value(s) obtained in step 474, and initializes the moving distance obtained by the sensor module 15. In this embodiment, the control module 17 calculates an average of the sample value(s) obtained in step 474 as the operating current value for said one of the reference heights, but is not limited thereto. In this embodiment, the moving distance is initialized to zero, but is not limited thereto. Then, the flow of the update procedure proceeds to step 472 for repeating the sub-procedure until the current height of the cutting module 13 is the minimum height.

In step 477, the control module 17 stops the cutting module 13 and the moving module 14.

In step 48, the control module 17 repeats the operation method based on the lookup table thus updated until the cutting module 13 is determined by the control module 17 to be at the desired height.

In response to determining that the cutting module 13 is at the desired height, in step 49, the control module 17 generates a message that is related to a state (e.g., whether or not the robot lawn mower 1 normally operates) of the robot lawn mower 1, and sends the message via the communication module 16 to the cloud server 3 so as to enable the cloud server 3 to transmit the message to the mobile device 2.

It should be noted that in this embodiment, the reference current values recorded in the lookup table of the storage module 12 are obtained by performing the update procedure. In some embodiments, the reference current values are recorded in the lookup table in advance. However, implementation of building the lookup table is not limited to the disclosure herein and may vary in other embodiments.

For explanation, an example of performing the operation method based on the lookup table as shown in Table 1 below is presented. In this example, the desired height is 2 cm, the current threshold is 5.5 A, the maximum height is 11 cm, and the minimum height is 1 cm. In a first round of performing the operation method, in step 41, since the reference current values less than the current threshold (i.e., 5.5 A) in Table 1 are 1 A, 2 A, 3 A, 4 A and 5 A, the control module 17 selects a greatest one of the reference current values thereamong as the target value, i.e., 5 A, and selects a least one of the reference heights that corresponds to the target value as the working height, i.e., 6 cm. In step 42, the control module 17 compares the working height with the desired height (i.e., 2 cm), and determines that the working height is greater than the desired height. Thus, the procedure flow of the operation method proceeds to steps 44 and 45 where the control module 17 controls the cutting module 13 to move to the working height and operate at the working height for mowing while the robot lawn mower 1 moves along the planned path. In response to determining that the robot lawn mower 1 has completed the planned path, in step 46, the control module 17 determines that the cutting module 13 is not at the desired height, and the procedure flow of the operation method proceeds to step 47 to perform the update procedure for updating the lookup table. After the update procedure has been completed, the lookup table shown in Table 1 is updated to be the lookup table shown in Table 2 below. Thereafter, the operation method is performed for a second round based on the lookup table shown in Table 2. In step 41, since the reference current values less than the current threshold (i.e., 5.5 A) in Table 2 are 1 A, 2 A, 3 A, 4 A and 5 A, the control module 17 selects a greatest one of the reference current values thereamong as the target value, i.e., 5A, and selects a least one of the reference heights that corresponds to the target value as the working height, i.e., 2 cm. In step 42, the control module 17 compares the working height with the desired height, and determines that the working height is not greater than the desired height. Thus, the procedure flow of the operation method proceeds to steps 43 and 45 where the control module 17 controls the cutting module 13 to move to the desired height and operate at the desired height for mowing while the robot lawn mower 1 moves along the planned path. In response to determining that the robot lawn mower 1 has completed the planned path, in step 46, the control module 17 determines that the cutting module 13 is at the desired height, so the procedure flow of the operation method proceeds to step 49. After that, the control module 17 generates the message and sends the message via the communication module 16 to the cloud server 3 so as to enable the cloud server 3 to transmit the message to the mobile device 2.

TABLE 1

| | | | | | | | | | | |
|---|---|---|---|---|---|---|---|---|---|---|
| Height | 10 | 9 | 8 | 7 | 6 | 5 | 4 | 3 | 2 | 1 |
| (cm) | | | | | | | | | | |
| Current | 1 | 2 | 3 | 4 | 5 | 6 | 7 | 8 | 9 | 10 |
| (A) | | | | | | | | | | |

TABLE 2

| | | | | | | | | | | |
|---|---|---|---|---|---|---|---|---|---|---|
| Height | 10 | 9 | 8 | 7 | 6 | 5 | 4 | 3 | 2 | 1 |
| (cm) | | | | | | | | | | |
| Current | 1 | 1 | 1 | 1 | 1 | 2 | 3 | 4 | 5 | 6 |
| (A) | | | | | | | | | | |

To sum up, for the robot lawn mower 1 and the operation method of the robot lawn mower 1 according to the disclosure, the cutting module 13 is controlled to move to the desired height when the working height is not greater than the desired height. On the other hand, the cutting module 13 is controlled to move to the working height when the working height is greater than the desired height, and then the update procedure will be performed to update the lookup table that records the reference heights and the reference current values corresponding respectively to the reference heights. In this way, the cutting module 13 may be capable of normally and stably operating according to the desired height indicated by the mowing command as much as possible, ensuring uniformity of lawn grass mowed by the robot lawn mower 1 and quality of mowing. At the same time, the cutting module 13 may be prevented from being damaged due to overload current.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An operation method of a robot lawn mower, the robot lawn mower including a device body, a storage module, a cutting module, a moving module and a control module, the control module being electrically connected to the storage module, the cutting module and the moving module, the cutting module being disposed on a lower portion of the device body and being movable in a vertical direction relative to the device body between a maximum height where the cutting module is closest to the device body and a minimum height where the cutting module is most away from the device body, the storage module storing a current threshold, data that is related to a planned path along which the robot lawn mower is to move for mowing, and a lookup table that records a plurality of reference heights of the cutting module and a plurality of reference current values corresponding respectively to the reference heights, the operation method being to be implemented by the control module and comprising:
according to the current threshold and the reference current values in the lookup table, selecting a working height from among the reference heights in the lookup table;
determining whether the working height is greater than a desired height;
adjusting a height of the cutting module by one of controlling the cutting module to move to the desired height in response to determining that the working height is not greater than the desired height, and controlling the cutting module to move to the working height in response to determining that the working height is greater than the desired height; and
after adjusting the height of the cutting module, controlling the cutting module to operate for mowing and controlling the moving module to drive the robot lawn mower to move along the planned path.

2. The operation method as claimed in claim 1, further comprising:
in response to determining that the robot lawn mower has completed the planned path, determining whether the cutting module is at the desired height;
in response to determining that the cutting module is not at the desired height, performing an update procedure that includes
controlling the moving module to drive the robot lawn mower to move forward,
for each of the reference heights recorded in the lookup table, controlling the cutting module to move to and operate at the reference height and obtaining an operating current value of operating current that is used by the cutting module operating at the reference height, and
updating the lookup table based on the operating current values that are obtained respectively for the reference heights; and
repeating the operation method based on the lookup table thus updated until that the cutting module is determined to be at the desired height.

3. The operation method as claimed in claim 2, the robot lawn mower further including a sensor module that is electrically connected to the control module and that is configured to obtain a moving distance of the robot lawn mower, every consecutive two of the reference heights recorded in the lookup table having a unit-height interval, wherein the update procedure includes:
controlling the cutting module to move to the maximum height;
after controlling the cutting module to move to the maximum height, performing a sub-procedure that includes steps of
a) determining whether a current height of the cutting module is the minimum height,
b) in response to determining that the current height of the cutting module is not the minimum height, controlling the cutting module to move downward in the vertical direction by the unit-height interval to one of the reference heights that is immediately below the current height, and then controlling the moving module to drive the robot lawn mower to move forward,
c) obtaining a sample value of the operating current used by the cutting module that is operating at the one of the reference heights,
d) during controlling the moving module to drive the robot lawn mower to move forward, determining whether the moving distance obtained by the sensor module is not less than a preset distance,
e) in response to determining that the moving distance is less than the preset distance, repeating steps c) and d), and
f) in response to determining that the moving distance is not less than the preset distance, determining the operating current value for said one of the reference heights based on the sample value(s) obtained in step c), initializing the moving distance obtained by the sensor module, and repeating the sub-procedure; and
in response to determining that the current height of the cutting module is the minimum height, stopping the cutting module and the moving module.

4. The operation method as claimed in claim 2, the robot lawn mower further including a communication module that is electrically connected to the control module and that communicates with a cloud server, the cloud server communicating with a mobile device, the operation method further comprising:
in response to determining that the cutting module is at the desired height, generating a message that is related to a state of the robot lawn mower, and sending the message via the communication module to the cloud server so as to enable the cloud server to transmit the message to the mobile device.

5. The operation method as claimed in claim 2, wherein updating the lookup table is to replace the reference current values that correspond respectively to the reference heights respectively with the operating current values that are obtained respectively for the reference heights.

6. The operation method as claimed in claim 1, wherein selecting a working height from among the reference heights includes:
selecting one of the reference current values that is less than the current threshold as a target value; and
selecting one of the reference heights that corresponds to the target value as the working height.

7. The operation method as claimed in claim 1, further comprising:
obtaining a mowing command that indicates the desired height.

8. A robot lawn mower, comprising:
a device body;
a moving module configured to drive said robot lawn mower to move;
a cutting module disposed at a lower portion of said device body, and configured to be movable in a vertical direction relative to said device body between a maximum height where said cutting module is closest to said device body and a minimum height where said cutting module is most away from said device body;
a storage module configured to store a current threshold, data that is related to a planned path along which said robot lawn mower is to move for mowing, and a lookup table that records a plurality of reference heights of said cutting module and a plurality of reference current values corresponding respectively to the reference heights; and
a control module electrically connected to said storage module, said cutting module and said moving module, and configured to implement an operation method that includes
according to the current threshold and the reference current values in the lookup table, selecting a working height from among the reference heights in the lookup table,
determining whether the working height is greater than a desired height,
adjusting a height of said cutting module by one of controlling said cutting module to move to the desired height in response to determining that the working height is not greater than the desired height, and controlling said cutting module to move to the working height in response to determining that the working height is greater than the desired height, and
after adjusting the height of said cutting module, controlling said cutting module to operate for mowing and controlling said moving module to drive said robot lawn mower to move along the planned path.

9. The robot lawn mower as claimed in claim 8, wherein the operation method further includes:
in response to determining that said robot lawn mower has completed the planned path, determining whether said cutting module is at the desired height;
in response to determining that said cutting module is not at the desired height, performing an update procedure that includes
controlling said moving module to drive said robot lawn mower to move forward,
for each of the reference heights recorded in the lookup table, controlling said cutting module to move to and operate at the reference height and obtaining an operating current value of operating current that is used by said cutting module operating at the reference height, and
updating the lookup table based on the operating current values that are obtained respectively for the reference heights; and
repeating the operation method based on the lookup table thus updated until that said cutting module is determined to be at the desired height.

10. The robot lawn mower as claimed in claim 9, further comprising a sensor module electrically connected to said control module, and configured to obtain a moving distance of said robot lawn mower, every consecutive two of the reference heights recorded in the lookup table having a unit-height interval, wherein the update procedure includes:
controlling said cutting module to move to the maximum height;
performing a sub-procedure that includes steps of
a) determining whether a current height of said cutting module is the minimum height,
b) in response to determining that the current height of said cutting module is not the minimum height, controlling said cutting module to move downward in the vertical direction by the unit-height interval to one of the reference heights that is immediately below the current height, and then controlling said moving module to drive said robot lawn mower to move forward,
c) obtaining a sample value of the operating current used by said cutting module that is operating at said one of the reference heights,
d) during controlling said moving module to drive said robot lawn mower to move forward, determining whether the moving distance obtained by said sensor module is not less than a preset distance,
e) in response to determining that the moving distance is less than the preset distance, repeating steps c) and d), and
f) in response to determining that the moving distance is not less than the preset distance, determining the operating current value for said one of the reference heights based on the sample value(s) obtained in step c), initializing the moving distance obtained by said sensor module, and repeating the sub-procedure; and
in response to determining that the current height of said cutting module is the minimum height, stopping said cutting module and said moving module.

11. The robot lawn mower as claimed in claim 9, further comprising a communication module electrically connected to said control module, and configured to communicate with a cloud server, the cloud server communicating with a mobile device, wherein the operation method further includes:
in response to determining that said cutting module is at the desired height, generating a message that is related to a state of said robot lawn mower, and sending the message via said communication module to the cloud server so as to enable the cloud server to transmit the message to the mobile device.

12. The robot lawn mower as claimed in claim 9, wherein updating the lookup table is to replace the reference current values that correspond respectively to the reference heights respectively with the operating current values that are obtained respectively for the reference heights.

13. The robot lawn mower as claimed in claim 8, wherein said control module is configured to:
select one of the reference current values that is less than the current threshold as a target value; and
select one of the reference heights that corresponds to the target value as the working height.

14. The robot lawn mower as claimed in claim 8, wherein said control module is further configured to obtain a mowing command that indicates the desired height.
